(19) United States
(12) Patent Application Publication
(10) Pub. No.: US 2021/0001912 A1
(43) Pub. Date: Jan. 7, 2021

(54) HOOD AND COVER

(71) Applicants: Nicholas DAVIES, London (GB); Kate MULLEN, London (GB)

(72) Inventor: Kate MULLEN, London (GB)

(21) Appl. No.: 16/980,577

(22) PCT Filed: Mar. 14, 2019
(86) PCT No.: PCT/GB2019/050716

§ 371 Date: Sep. 14, 2020

(30) Foreign Application Priority Data
Mar. 14, 2018 (GB) 1804088.1

(51) Int. Cl. B62B 9/14; A47D 15/00; A47D 13/02

(52) U.S. Cl. CPC B62B 9/142; B62B 2204/00; A47D 13/02; A47D 15/00

(57) ABSTRACT

A hood (110) for mounting to a child carrier, the hood comprising a pair of side walls 16a, 116b, a top wall (120) and a mar wall (118) defining a compartment therebetween. The hood further comprises a first fan unit (126) comprising a fan configured, in use, to draw ambient external air into the compartment, and a second fan unit (128) comprising a fan configured, in use, to draw air from within the compartment to the environment outside the compartment. The first and second fan units are mounted and sealed within a respective opening in a different respective one of the side walls, top wall and rear wall such that, in use, an air flow path is defined through a volume of the compartment between the first and second fan units. A removable cover assembly is also provided.

### FIELD OF THE INVENTION

This invention relates generally to a hood and a cover and, more particularly, to a hood and a cover for a child carrier or transport vehicle, such as a carrycot, pram, baby-buggy, stroller or Moses basket, configured to provide protection against pollutants and/or thermal comfort, in use, to a child being transported, or otherwise located, therein.

### BACKGROUND OF THE INVENTION

It is common to provide a removable cover for devices such as prams, strollers, carrycots, baby-buggies and Moses baskets, to protect an infant or young child being transported (or even just resting) therein from the elements when outdoors. Thus, removable rain covers are usually provided for strollers, to protect a child in wet weather, and removable parasols or other sun shading devices may also be provided, to shield a child from the sun's rays in hot weather.

It is less common, but nevertheless also known, to provide a cover for a stroller or other child transport vehicle, that is configured and intended to protect an infant or child seated therein against air pollution. For example, U.S. Pat. No. 6,068,322 describes a transparent canopy that, in use, covers an infant seated within a baby-buggy to define a compartment around them, and comprises a battery-powered fan unit including a carbon-impregnated filter for blowing filtered ambient air into the compartment. The filter unit is located and configured to blow the filtered (ambient) air into the top of the compartment from the rear (between the buggy seat back and the canopy). The canopy extends and hangs down over the seated child and the bottom of the canopy is open. Operation of the filter unit creates positive pressure within the compartment so that filtered air flows downwardly therethrough (relative to the seated child's face and body), from the filter unit to the open end of the compartment. A mesh insert in the canopy at the ‘front’ of the compartment provides ventilation and is intended to prevent heat build up.

However, the above-described cover is intended to protect a seated (i.e. inclined) child and is not configured for use with (and the principle would be difficult to apply to) a carrycot, pram or moses basket, wherein the infant is lying substantially flat on their back, as it would be difficult to provide the required open end of the compartment without additional support features. Even if this were considered possible, the arrangement would not work as intended, because it also relies on a mechanism known as “flotation”, more widely known as “hot air rises”. Thus, as the cooler air from the fan unit is directed downwardly through the compartment, the warmer air toward the bottom will rise up through the canopy and (in theory, at least) be expelled through the mesh insert. Furthermore, even if a similar arrangement were to be realisable for a carrycot, say, there is no directional control of the air flow over the infant as the positive air pressure and air flow will tend to be equal throughout the compartment, which would result in air from the fan unit blowing directly onto the prone infant's face and around their neck and shoulders, which is clearly undesirable, especially in respect of very young babies. More generally, the transparent canopy and open end do not provide complete protection for the child, and are particularly inadequate in protecting the child from the sun or, indeed, very hot temperatures as the configuration of the arrangement depends, additionally, on movement of the underlying device to regulate temperature and prevent heat build-up, not to mention the fact that the cover is really only intended for short term periods of use to transport a child outdoors between one location and another, and would not be suitable for longer term, stationary periods, to protect a child as it slept, for example.

It is an object of the present invention to address at least some of these issues.

### SUMMARY OF THE INVENTION

In accordance with an aspect of the invention, there is provided a hood for a child carrier comprising:
a pair of side walls, a top wall and a rear wall defining a compartment therebetween;
a first fan unit comprising a fan configured, in use, to draw ambient external air therethrough into the compartment, and
a second fan unit comprising a fan configured, in use, to draw therethrough air from within the compartment to the environment outside the compartment;
said first and second fan units being mounted and sealed within a respective opening in a different respective one of the side walls, top wall and rear wall such that, in use, an air flow path is defined through a volume of said compartment between said first and second fan units.

In accordance with another aspect of the present invention, there is provided a removable cover assembly for an infant carrier or child transport device comprising a receptacle or seat for receiving an infant or child, in use, the cover assembly comprising a cover formed of a pair of side walls, a top wall and a front wall, said side, top and front walls defining a canopy configured to fit over said receptacle or seat to form a compartment enclosing an infant or child therein, in use; wherein said canopy is formed of a flexible material and the cover assembly further comprises:
a first fan unit comprising a fan configured, in use, to draw ambient external air therethrough into the compartment, and
a second fan unit comprising a fan configured, in use, to draw therethrough air from within the compartment to the environment outside the compartment;

said first and second fan units being mounted and sealed within a respective opening in a different respective one of the side walls, top wall and front wall of said cover such that, in use, an air flow path is defined through a volume of said compartment between said first and second fan units.

Unless specified otherwise, the features described below are applicable to both the hood and the removable cover assembly.

Optionally said fan unit may also further comprise a filter member. Optionally said first fan unit may comprise a recess for receiving a replaceable filter member in an air flow path of said ambient external air. This replaceable filter member may advantageously be formed of an active carbon filter. In addition to these aspects, at least one of the first and second fan units may additionally comprise a power supply, and each said fan may be electrically coupled to the, or each respective, power supply. The power supply, or each power supply, may also comprise a switch mechanism for selective operation thereof. The power supply, or each power supply, may also be formed of at least one battery. Optionally at least one of said first and second fan units may comprise a power supply recess for removably receiving at least one battery and including a contact for electronically coupling said at least one battery, in use to a respective fan.

Optionally only one of said first and second fan units may comprise a power supply, and said one of said fan units and the other of said fan units are both electrically coupled thereto. The other of said fan units can optionally be electrically coupled to one of said fan units via a flexible electrical connector.

The hood or cover assembly may also advantageously comprise a temperature sensor configured, in use, to obtain data representative of the temperature within the compartment. The hood or cover assembly may also optionally comprise a visual temperature indicator configured, in use, to represent said internal temperature data.

The fan units may also additionally be comprised of a control unit configured, in use, to selectively vary the speed of rotation of said fans. The temperature sensor may also optionally be communicably coupled to the control unit, and the control unit may be configured to vary the speed of rotation of said fan in response to changes in the internal temperature. Optionally the electronic control unit can have included a pre-programmed temperature range and is configured, in use, to compare said temperature data against said pre-programmed temperature range, and selectively operate the fans based on this comparison.

In addition to the previous features, the hood or cover assembly may preferably further comprise an air quality sensor configured, in use, to obtain data representative of the air quality, and optionally there may be included a visual display unit configured, in use, to present said air quality data. The temperature and/or air quality sensor may optionally be communicably coupled with a program on a user mobile device.

The first fan unit and the second fan unit can be mounted and sealed in a different respective side wall so as to oppose each other.

The hood can further comprise a front wall extendable forwardly from the hood (i.e. away from the rear wall of the hood). The hood can comprise a pocket for storing the front wall (e.g. in a folded state) when not extended. The pocket can be located on the inner surface of the hood, or the outer surface of the hood. The pocket can comprise a zip or hook-and-loop fastener for opening and closing the pocket. The front wall can be made from a flexible material. The front wall can be made from a mesh or net material. The front wall can comprise an elasticated edge.

The hood can comprise mounting points for mounting to a receptacle of a child carrier. The receptacle can define a cavity for receiving a child and the hood can be configured to be mounted on the receptacle over the cavity.

According to another aspect of the invention, there is provided a child carrier (e.g. a carrycot, bassinet, Moses basket, seat unit for a pushchair, car seat, etc.) comprising:
a receptacle defining an open cavity for receiving an infant in use;
a hood according to the above aspect mounted at one end of the receptacle, the compartment being defined over the cavity.

The hood can be pivotably mounted to the receptacle and can be moveable relative to the receptacle between an expanded state and a collapsed state.

Where the hood comprises a front wall, the front wall can be extendable from the hood towards an opposing end of the receptacle. The front wall of the hood can comprise fastening means for fastening the front wall to the opposing end of the receptacle, e.g. an elasticated edge, or fastening means such as zip, button or hook-and-loop fastening means. When the hood is in the expanded state and the front wall is extended from the hood to the opposing side of the receptacle, the hood and front wall can completely enclose the receptacle from above such that the cavity is completely enclosed.

According to another aspect of the invention, there is provided a child transport device (e.g. pram, pushchair, stroller) comprising:
a child carrier according to the above aspect;
a frame permanently attached or removably attachable to the child carrier; and at least one wheel permanently attached or removably attachable to the frame.

These and other aspects of the present invention will be apparent from the following detailed description.

### BRIEF DESCRIPTION OF THE DRAWINGS

An embodiment of the present invention will now be described, by way of example only, and with reference to the accompanying drawings, in which:

FIG. 1 is a schematic front/right side perspective view of a cover assembly according to an exemplary embodiment of the present invention, mounted over a carrycot;

FIG. 2 is a schematic front/left side perspective view of the cover assembly of FIG. 1;

FIG. 3 is a schematic right side view of the cover assembly of FIGS. 1 and 2;

FIG. 4 is a schematic left side view of the cover assembly of FIGS. 1 and 2;

FIG. 5 is a schematic side view of a typical carrycot on which a cover assembly according to an exemplary embodiment of the present invention may be used;

FIG. 6 is a schematic rear view of the cover assembly of FIGS. 1 and 2;

FIG. 7 is a schematic side view of the cover assembly of FIGS. 1 and 2, when in use;

FIG. 8 is a schematic perspective view of a first fan unit of a cover assembly according to an exemplary embodiment of the present invention;

FIG. 8A is a schematic exploded view diagram of the filter member of FIG. 8;

FIG. 9 is an exploded view of the fan unit of FIG. 8;

FIG. 10 is a schematic perspective diagram of a carrycot having a cover assembly according to an exemplary embodiment of the present invention fitted thereon, with the fabric of the carrycot hood and the fabric of the cover assembly omitted to illustrate the location of the first and second fan units in relation to the carrycot receptacle;

FIG. 11 is schematic side view of a cover assembly according to an exemplary embodiment of the present invention, in use on a carrycot, with the fabric of the cover illustrated as transparent so as to illustrate the location of the first and second fan units in relation to the carrycot;

FIG. 12 is a schematic plan view of the arrangement of FIG. 10, illustrating the directed air flow between the first and second fan units through a volume of the compartment defined between the carrycot receptacle and the cover assembly;

FIG. 13 is a schematic plan view of the cover assembly of FIGS. 1 and 2;

FIG. 14 is a schematic front view of the cover assembly of FIGS. 1 and 2; and

FIG. 15 is a schematic front view of a cover assembly according to a second exemplary embodiment of the present invention;

FIG. 16 is a side view of a hood as part of a child carrier mounted on a wheeled frame.

FIG. 17 is a rear view of the hood, child carrier and wheeled frame of FIG. 16.

FIG. 18 is a side view of the hood, child and wheeled frame of FIG. 16 with a front wall in an extended state.

### DETAILED DESCRIPTION

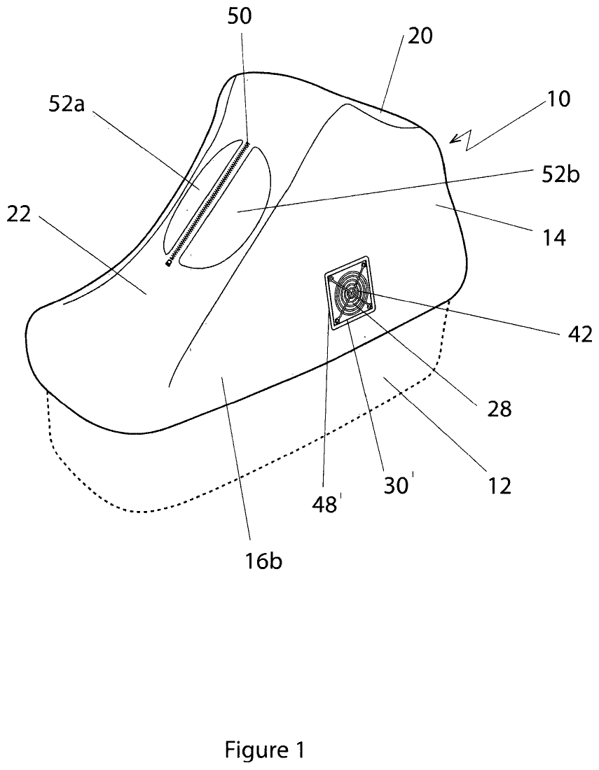

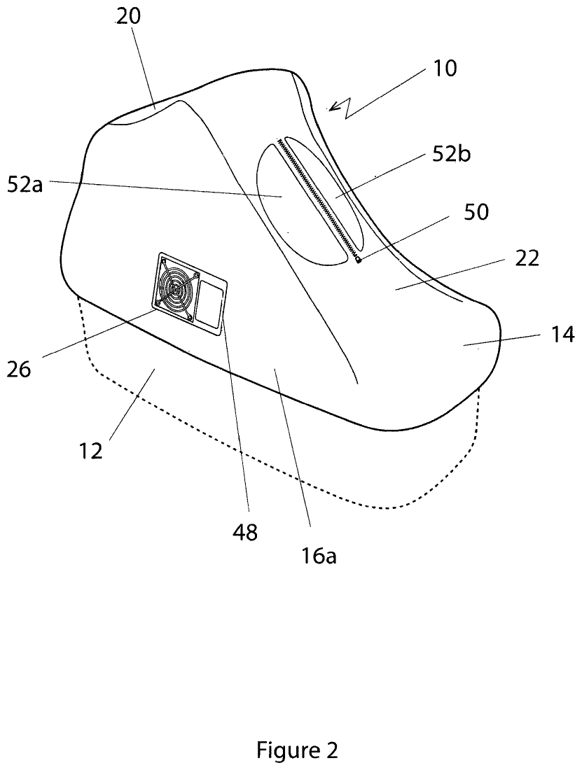

Referring to FIGS. 1 to 4 of the drawings, a cover assembly 10 for a carrycot 12 is illustrated. The cover assembly comprises a cover 14 formed of a flexible, opaque material and defining a pair of opposing ‘side’ walls 16a, 16b, a ‘rear’ wall 18, a top wall 20 and a front wall 22. Directional adjectives such as front, rear, top, bottom, side, left, right refer to the present exemplary embodiment of the present invention, intended for a carrycot or the like (in which the infant lies substantially flat within a horizontal receptacle) and when oriented for normal use thereon, but it will be apparent to a person skilled in the art that the invention may be placed in alternative orientations for use with child transport devices in which a child is seated and inclined, and the present invention is not necessarily intended to be limited in this regard.

The side, rear, top and front walls 16a, 16b, 18, 20, 22 may comprise separate panels of material, joined together at their respective side edges, or one or more (or all) of the panels may, in fact, be formed integrally with each other, and the present invention is not necessarily intended to be limited in this regard. The opaque material forming the walls 16a, 16b, 18, 20, 22 may comprise a fabric of around 270-300 gsm and be resiliently flexible in that it has a relatively small amount of elasticity or stretch incorporated therein. For example, a polyester or polyester mix including a small percentage (e.g. less than 10%) of elastic polyurethane fibre or fabric, or indeed a Gore-Tex® stretch material (or similar) may be used. Other suitable materials will be apparent to a person skilled in the art.

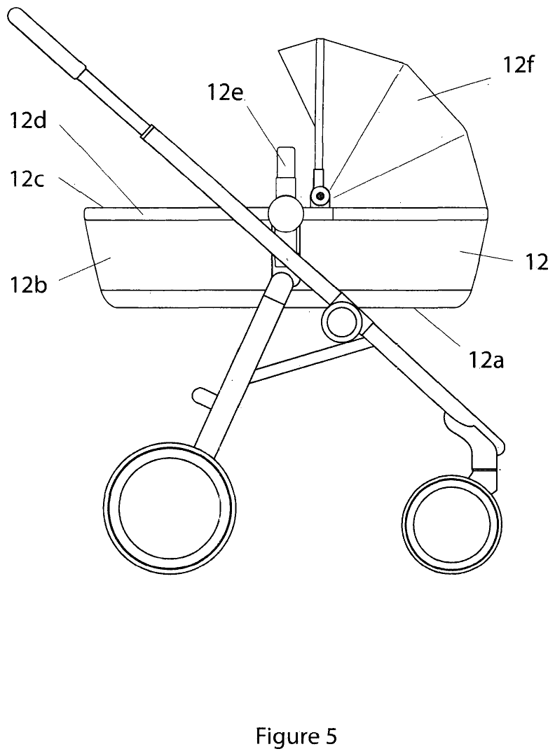

Referring to FIG. 5 of the drawings, a typical carrycot 12 comprises an elongate “bucket” like receptacle, having a substantially flat base 12a with a circumferential side wall 12b defining an open upper end 12c having a rib or frame member 12d around it. A bumper bar and handle assembly 12e may be provided generally centrally along the length of the receptacle, and which spans the width thereof. A framed hood 12f is typically mounted at one end of the receptacle, the hood typically configured to be selectively moveable between the extended or raised configuration shown and a lowered configuration as will be well known to a person skilled in the art. Many such carrycots also include an integral cover member that, when deployed, extends (substantially parallel to the flat base) from the end of the receptacle opposite the hood, over the open end of the receptacle up to around the location at which the front of the hood is mounted thereto. The remaining portion of the open end of the receptacle (under the hood 12f when it is in the raised configuration illustrated) can be considered to define the end of the receptacle at which an infant's head would be located when they are lying flat in the carrycot.

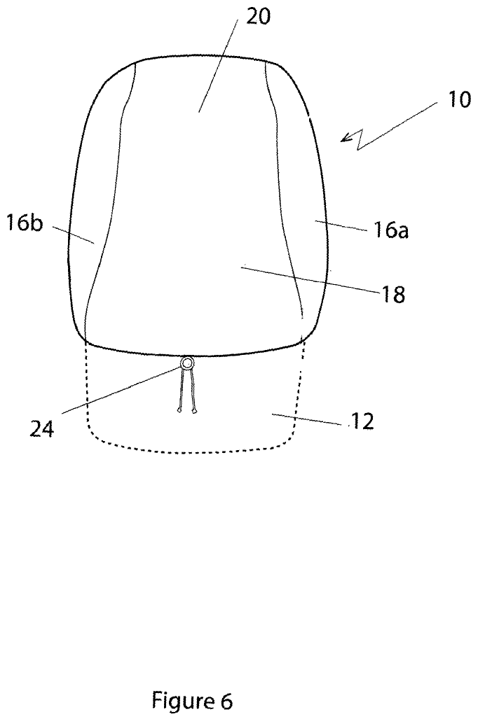

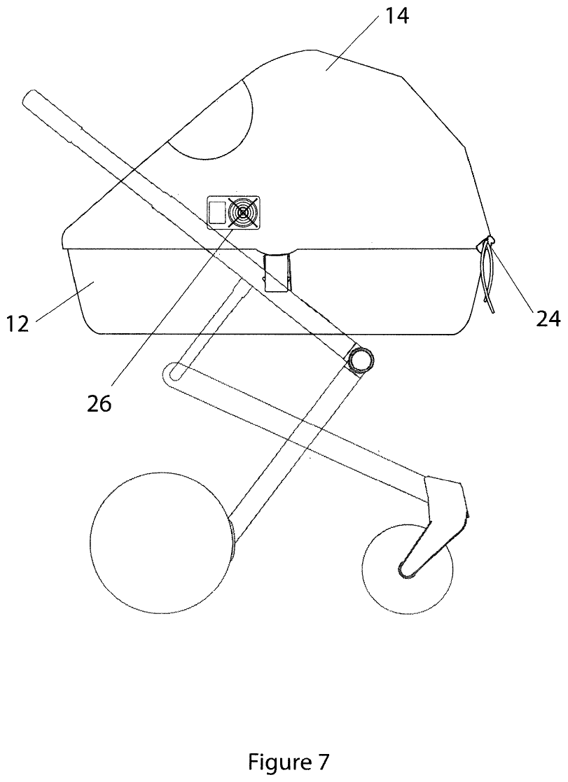

Referring back to FIGS. 1 to 4, it can be seen that the rear and top walls slope or curve away from the ‘rear’ edges of the side walls 16a, 16b to an apex, and the front wall 22 slopes or curves from the apex to the ‘front’ edges of the side walls 16a, 16b, such that the outer profile of the cover defines a dome-like region at one end and a front cover region at the opposing end. When the cover assembly is in use, the hood 12f of the carrycot 12 is in the raised or extended configuration illustrated in FIG. 5 of the drawings, and the cover assembly is supported by the hood 12f (which is received within the above-mentioned dome-like region of the cover) over the receptacle opening. The open edge of the cover is then secured around the upper edge of the receptacle by means of a fastening means. In an exemplary embodiment, the fastening means may be facilitated by a length of cord or elastic, held within a circumferential loop that extends around the open edge of the cover and can be stretched or otherwise adjusted to widen the cover opening and enable it to be fitted over a receptacle of any reasonable size. Referring additionally to FIGS. 6 and 7 of the drawings, the cover may then be secured on the carrycot by means of a toggle 24 or similar fastening mechanism.

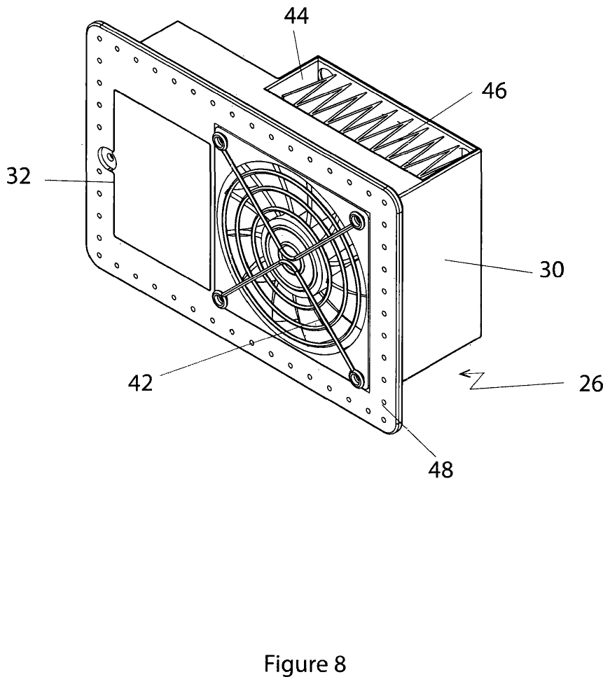

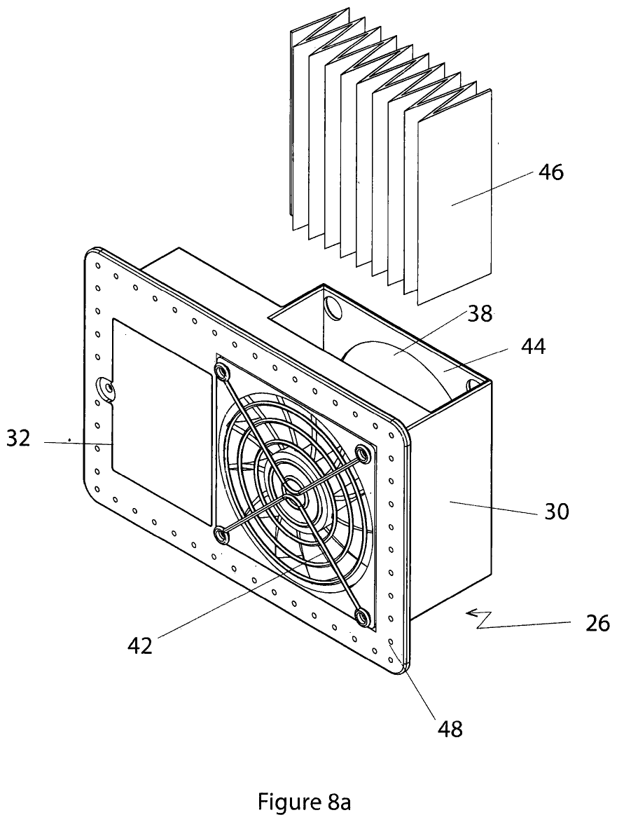

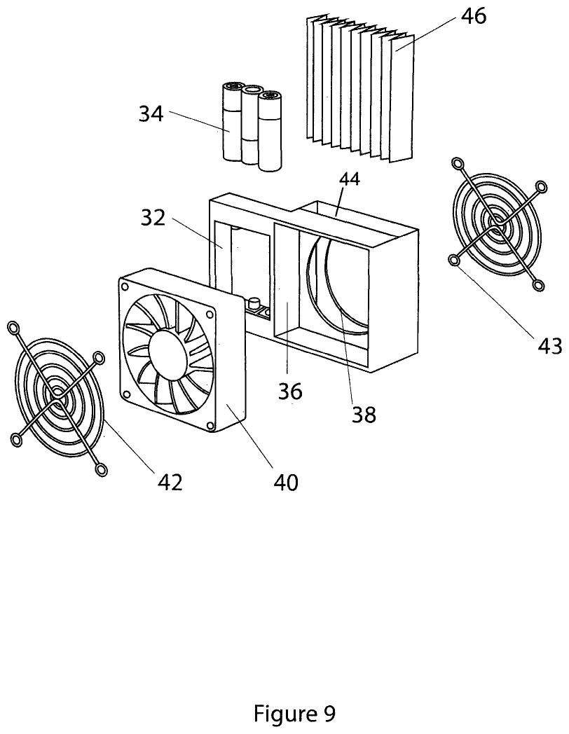

The cover assembly further comprises first and second fan units 26, 28. Referring additionally to FIGS. 8, 8a and 9 of the drawings, the first fan unit 26 comprises a generally rectangular housing 30 defining, on one side, a power supply recess 32 arranged and configured to receive a number of traditional batteries 34. The power supply recess may include a removable cover (not shown) for selectively removing and replacing the batteries. The housing defines, on the other side, adjacent to the power supply recess 32, a fan recess 36 which is open at the front and has a rear wall having a large aperture 38 therein. A fan 40 is mounted within the fan recess 36 and a fan grill 42 is mounted over the open front of the fan recess 36. At the rear of the fan recess 36, a filter recess 44 is provided and configured to removably receive therein a filter member 46 such that a fluid flow path is defined between the fan 40 and the filter member 46 through the aperture 38. A filter grill 43 is mounted at the rear of the filter recess 44. A removable cover (not shown) may be provided over the filter recess opening 44 to enable the filter member 46 to be selectively removed and replaced as required.

The filter member 46 may, for example, comprise a replaceable active carbon filter of a known type, which in this case is in the form of a corrugated cartridge of activated carbon filter mesh, although other replaceable filter members will be known to a person skilled in the art, and the present invention is not necessarily intended to be limited in this regard. Nevertheless, active carbon filter members are known to trap all particles with dimensions larger than 3-5 microns and are an excellent barrier against industrial dust, exhaust gas and smaller microorganisms, a significant cause of lung disease, and are therefore considered to be particularly useful in at least some exemplary embodiments of the present invention.

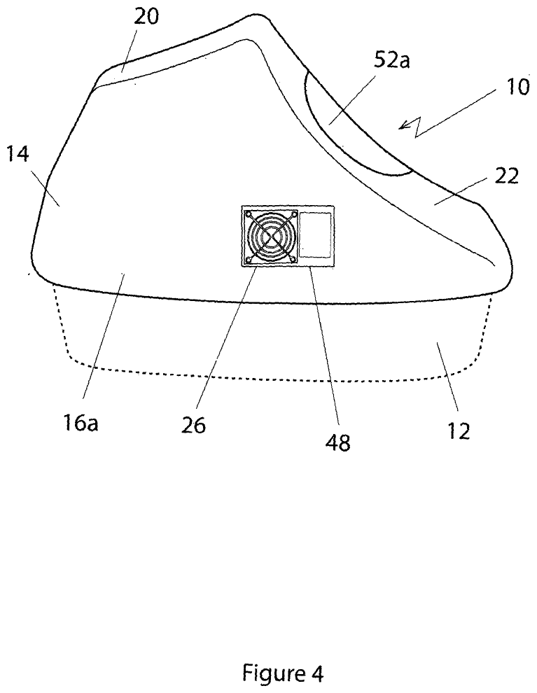

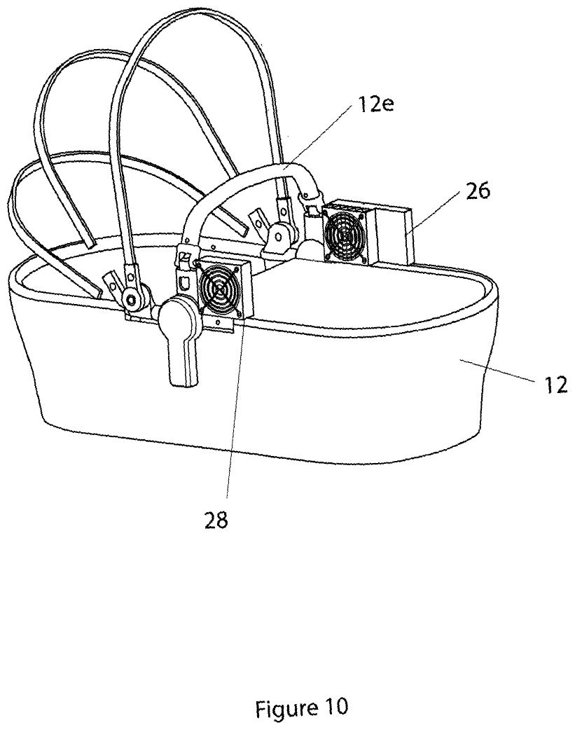

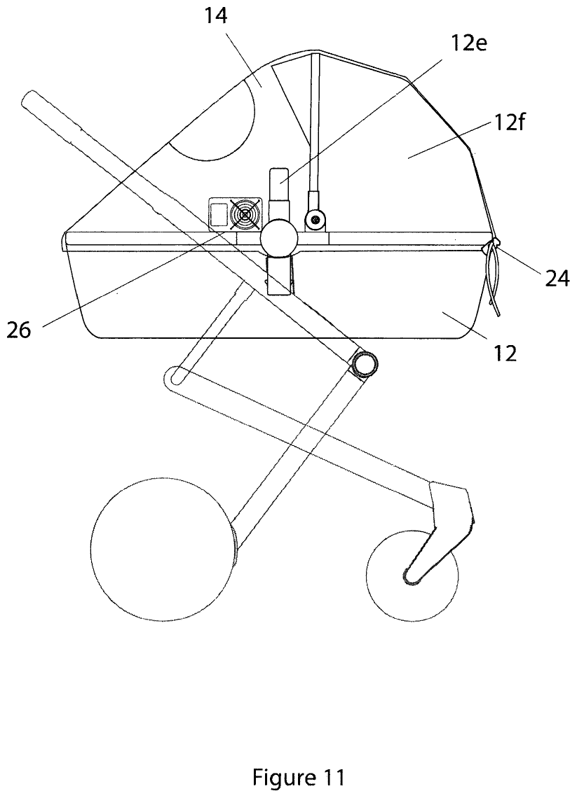

When the fan unit 26 is fully assembled, the fan 40 is electrically connected to the power supply defined by the batteries 36 within the power supply recess 32. The housing 30 defines, around its periphery adjacent its front face, a frame portion 48 (not shown in FIG. 9). The housing 30 is mounted within an opening in a side wall 16a of the cover 14, such that the frame portion 48 thereof lies against the outer surface of the cover and the rest of the housing 30 is on the inside of the cover 14. Thus, and as shown in FIG. 4 of the drawings, when the cover is fully assembled, the only part of the housing 30 that is visible from the outside is the frame portion 48, the fan grill 42 and the cover of the power supply recess 32 which lie substantially flush against the outer surface of the cover 14. The fan unit housing 30 is preferably formed of a lightweight material, such as plastic, so as not to avoid putting too much strain on the fabric of the cover 14 and causing deformation thereof. That said, in use, the part of the housing 30 that is located inside the cover 14 actually rests on the upper edge of the carrycot 12, adjacent the bumper bar 12e, in use, as shown in FIGS. 10 and 11 of the drawings.

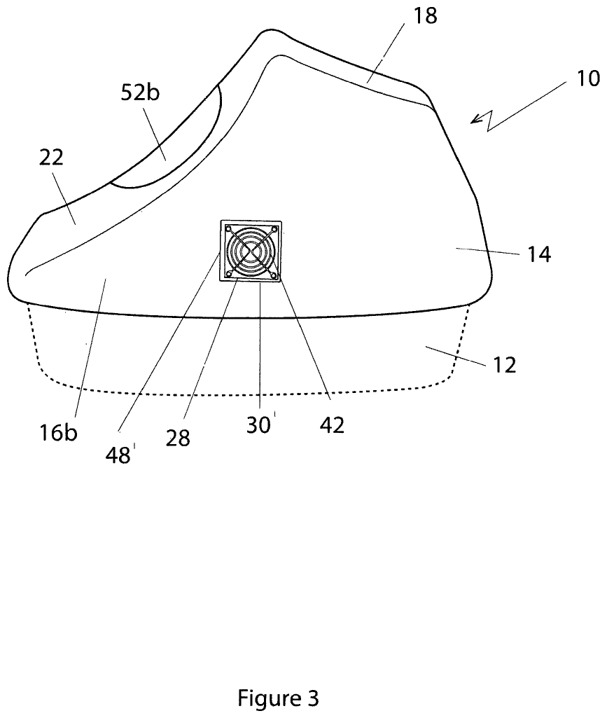

The second fan unit 28 may, in some exemplary embodiments of the present invention, be almost identical to the first fan unit 26 described above and include the power supply as defined by the power supply recess and the batteries 36, but not the filter recess 44 and filter member 46 (or, indeed, the aperture 38 in the rear wall of the fan recess 36). However, in some exemplary embodiments, the power supply portion of the second fan unit 28 may also be eliminated, as in the exemplary embodiment illustrated herein, such that the second fan unit 28 comprises only the fan recess 36, fan 40 and fan grill 42, aperture 38 substantially as described above in relation to the first fan unit 26. Once again, the housing 30′ of the second filter unit 28 defines, around its periphery adjacent its front face, a frame portion 48′. The housing 30′ is mounted within an opening in the opposite side wall 16b of the cover 14 to that in which the first filter unit 26 is mounted, such that the frame portion 48′ thereof lies against the outer surface of the cover and the rest of the housing 30′ is on the inside of the cover 14. Thus, and as shown in FIG. 3 of the drawings, when the cover is fully assembled, the only part of the housing 30′ that is visible from the outside is the frame portion 48′ and the fan grill 42 which lie substantially flush against the outer surface of the cover 14. The fan unit housing 30′ is, once again, preferably formed of a lightweight material, such as plastic, so as not to avoid putting too much strain on the fabric of the cover 14 and causing deformation thereof. That said, in use, and as before, the part of the housing 30′ that is located inside the cover 14 actually rests on the upper edge of the carrycot 12, adjacent the bumper bar 12e, in use, as shown in FIGS. 10 and 11 of the drawings.

As the second fan unit 28 does not have its own power supply in the exemplary embodiment illustrated, there is a need to provide an electrical connection from the power supply of the first fan unit 26 to the second fan unit 28. This may be achieved, for example, by running a flexible electrical connector (not shown) in the peripheral loop around the open end of the cover provided for the fastening cord, for example, from the power supply of the first fan unit 26 to the second fan unit 28, although other methods of achieving this may be apparent to a person skilled in the art and the present invention is not necessarily intended to be limited in this regard.

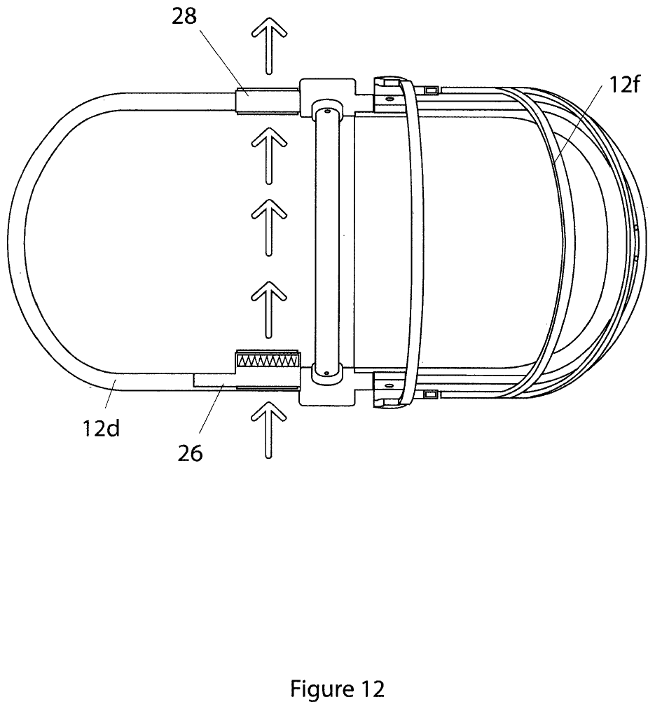

The fan 40 of the first fan unit 26 is configured, in use, to draw ambient air from the outside of the cover 14, through the filter member 46, into the compartment defined between the receptacle of the carrycot and the cover assembly 10. The fan 40 of the second filter unit 28 is configured, in use, to draw air from within the above-mentioned compartment and into the environment surrounding the assembly. Thus, and referring to FIG. 12 of the drawings, a controlled air flow path is defined between the two filter units 26, 28, across the top of the receptacle where the infant's head would be located, in use, and also around the inner surface of the dome-like portion of the cover 14, but without extending into the receptacle itself or blowing air directly onto or around an infant lying within the carrycot receptacle.

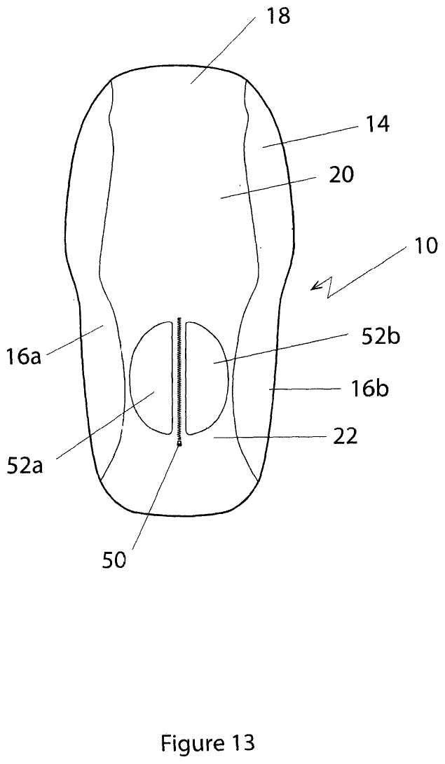

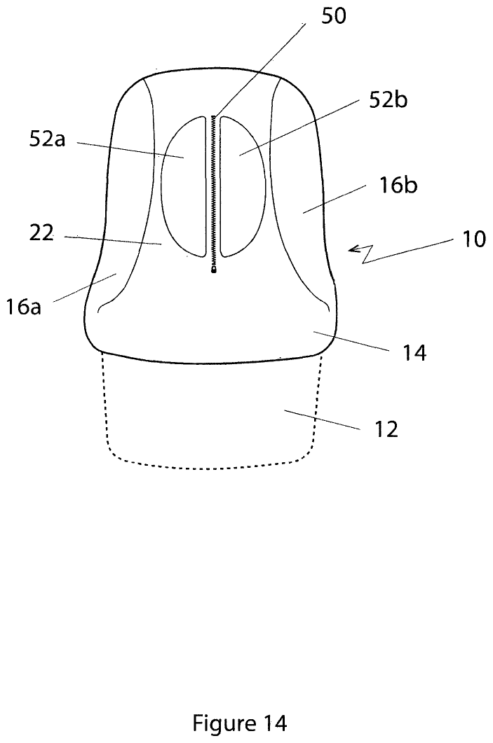

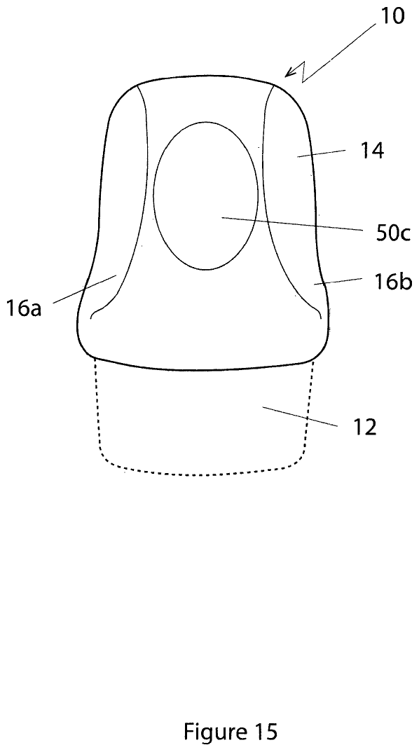

As a result, the ambient air can be filtered, and the temperature within the compartment actively controlled, without disturbing the infant or causing it any distress. As shown in FIGS. 13 and 14 of the drawings, in an exemplary embodiment of the present invention, a slit may be provided along a portion of the length of the front wall 22 of the cover 14, the slit being configured to be selectively opened and closed by means of a zip 50, for example, to enable easy access to an infant within the carrycot receptacle. In addition, a pair of transparent “windows” 52a, 52b may be provided in the front wall 22 of the cover 14, one on each side of the zip 50, to enable the infant in the carrycot receptacle to be viewed from the outside. In the alternative exemplary embodiment of the case assembly 10′ illustrated in FIG. 15, there is no slit or zip and, instead, a single, generally central, transparent viewing window 52c is provided instead. In both cases, the window(s) may be formed of a flexible, substantially transparent plastic material, of the type used in conventional rain covers and the like, although the present invention is not necessarily intended to be limited in this regard.

In some exemplary embodiments, a temperature sensor (not shown) may be provided within the compartment formed, in use, between the cover 14 and the carrycot receptacle to obtain data representative of the temperature therein. Such temperature data may, for example, be used to provide a temperature display, on (or visible from) the outside of the cover 14. In other exemplary embodiments, the temperature data may, alternatively or in addition, be used to control the speed of the fans 40 in the fan units 26, 28, thereby to increase their speed of rotation if the temperature is above a predetermined threshold and reduce their speed of rotation if the temperature in the compartment falls below a predetermined threshold. An electronic control unit to achieve this functionality may, for example, be provided in the first fan unit housing 30. The cover 14 may include a fastening member at a convenient location on its inner surface, for receiving and removably holding accessories such as a temperature sensor, toy, mobile, etc.

In yet another exemplary embodiment, an air quality sensor (not shown), may be provided within the carrycot receptacle to obtain data representative of the amount of pollution or, harmful air particulates and substances (such as smog) in the surrounding area to the carrycot. Such air quality data may, for example, be used to provide a display indicative of the pollution levels. This display may be shown on a screen or display unit fitted to the outside of the carrycot cover, such that it can be seen by those looking at the carrycot.

In other exemplary embodiments, said temperature and/or air quality sensor may be communicably coupled with a program or application on a user mobile device.

In addition to providing the fan units as part of a removable cover assembly, the fan units can also be integrated into a hood for mounting to a child carrier.

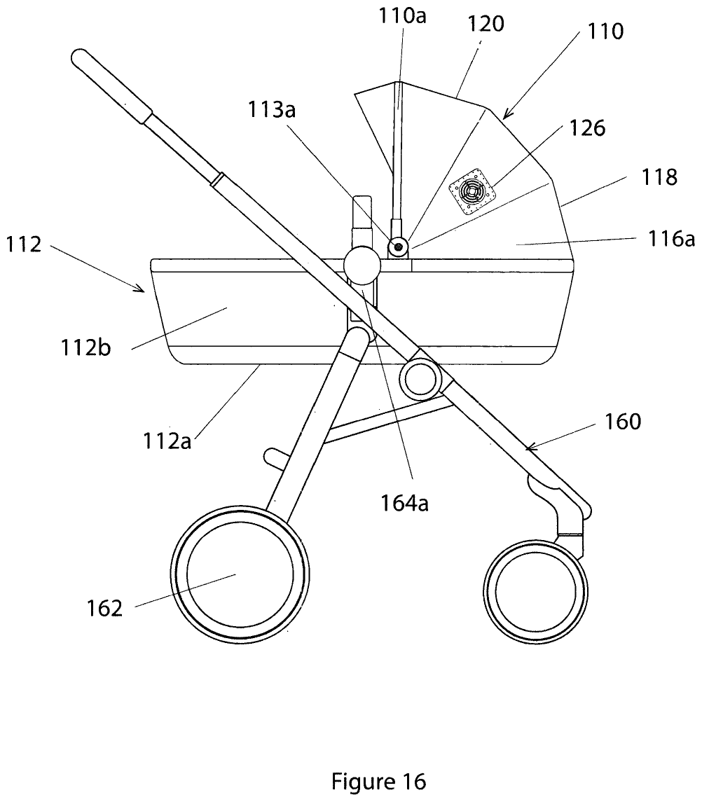

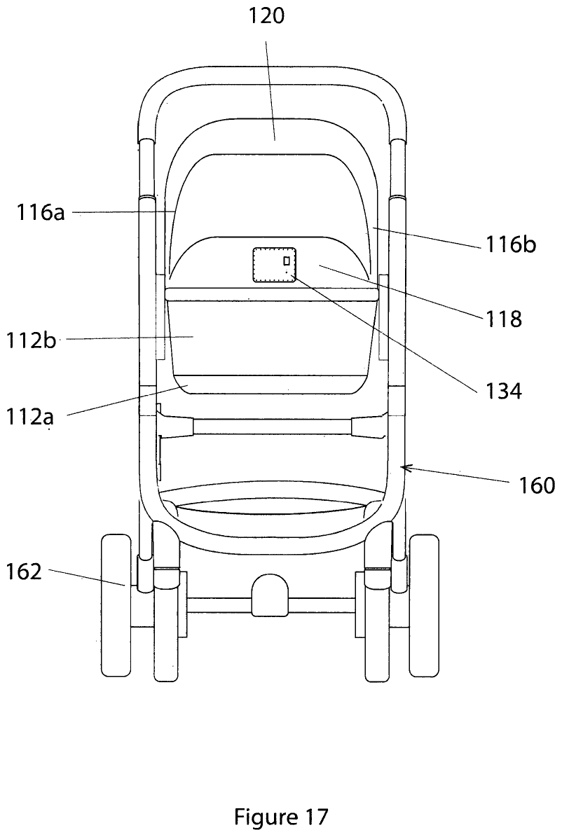

FIGS. 16-18 show a child carrier comprising a hood 110 mounted at one end of a receptacle 112. The receptacle has a base 112a and a side wall or side walls 112b extending circumferentially around the base 112a that define an open cavity within the receptacle for receiving a child in use. Although the example receptacle shown in FIGS. 16-18 is in the form of a carrycot with a flat base, other forms or receptacle for carrying an infant or a child can be used, e.g. a seat unit for a pushchair, or a car seat.

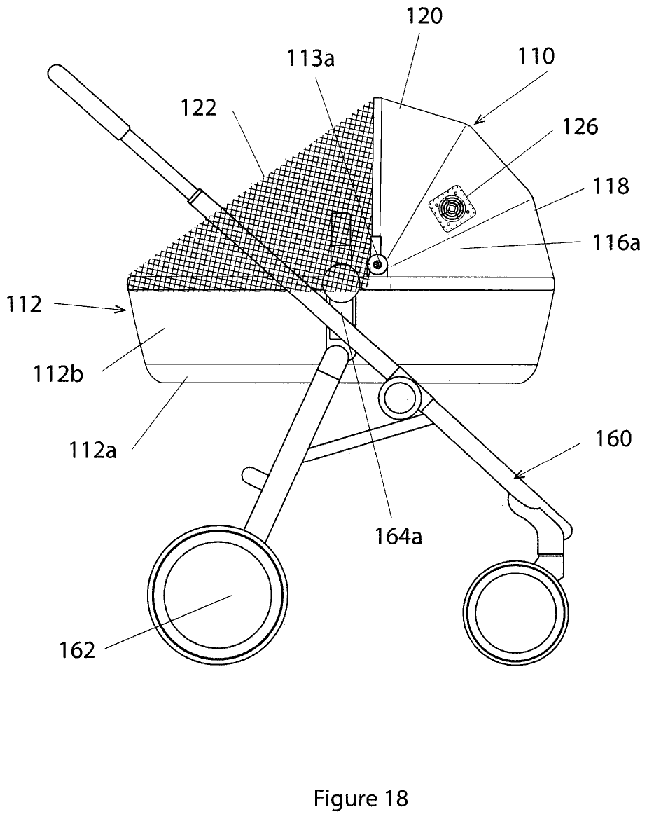

The hood is symmetrical on both sides and therefore in FIGS. 16 and 18, only one side of the hood 110 is shown. The hood 110 comprises a front arch member 110a that extends transversely over the cavity and is pivotably mounted at both ends to the top of the receptacle 112 at pivots 113a, 113b. FIG. 16 shows the front arch member 110a in a raised position in which the front arch member 110a is orientated substantially orthogonal to the base 112a. The front arch member 110a can be selectively moved about the pivots 113a, 113b between this raised position and a lowered position in which the front arch member 110a is orientated substantially parallel to the base 112a. Flexible material is attached between the front arch member 110a and one end of the receptacle 112 to form a pair of side walls 116a, 116b, a rear wall 118 and a top wall 120 of the hood 110. The hood material can be attached to the receptacle 112 using traditional fastening means such as zip fasteners, button fasteners, hook-and-loop fasteners etc. The hood 110 also comprises internal arch members (such as those shown in FIG. 10) to provide additional support to the flexible material.

When the front arch member 110a is in its lowered position, the flexible material is folded and the hood 110 is in a collapsed state. When the front arch member 110a is moved to its raised position, the flexible material unfolds and the hood 110 is in an extended state in which the side walls 116a, 116b. rear wall 118, and top wall 120 form an open compartment at one end of the receptacle 112 over the cavity. The front arch member 110a may be releasably locked in the raised position relative to the receptacle 112, e.g. by a releasable snap fit connection, so that the hood 110 can stay extended until the user decides to collapse it.

The hood 110 further comprises a first fan unit 126 and a second fan unit 128. The first fan unit 126 is mounted in one side wall 116a of the hood 110 and the second fan unit 128 is mounted in the other side wall 116b of the hood 110 so that the fan units 126, 128 generally oppose each other. Similar to the cover assembly 10, the first fan unit 126 comprises a fan configured, in use, to draw ambient external air into the compartment and the second fan unit 128 comprises a fan configured, in use, to draw air from within the compartment to the environment outside the compartment.

Thus, a controlled air flow path is defined between the two fan units 126, 128 over the top of the receptacle 112 where the child's head would be located, in use. The first fan unit 126 and second fan unit 128 do not necessarily have to be mounted on opposing side walls of the hood 110, and each could be mounted on a different side wall, top wall or rear wall, as long as an air flow path is defined through a volume of the compartment between the first and second fan units.

The first and second fan units 126, 128 are powered by an external power supply 134 that is mounted on or within the rear wall 118 of the hood 110. Alternatively, the power supply could be mounted on or within the base 112a or side wall 112b of the receptacle 112, or mounted within the housing of one or both of the fan units 126, 128. The power supply may receive traditional batteries, or may be a rechargeable power supply. Electrical wires (not shown) can be sewn into the walls of the hood 110 and/or the receptacle 112 between the power supply and the first and second fan units 126, 128 to provide power to the fan units. The electrical wires may be covered in foam to improve the feel of the hood 110. It will be recognised that due to the presence of the first and second fan units in the walls of the hood 110, the hood 110 may not be completely flat in its collapsed state and may only collapse down to a partially collapsed state.

The first and second fan units 26, 28 described above in relation to the cover assembly 10 are substantially identical to the first and second units 126, 128 of the hood 110 and the description of the first and second fan units 26, 28 is equally applicable to the first and second fan units 126, 128. For example, the details of the housing, the way in which the fan units are mounted in the walls, the filter member etc. are all equally applicable to the first and second fan units 126, 128 of the hood 110. A detailed description of the first and second fan units 126, 128 will therefore not be repeated here.

The hood 110 can further comprise a front wall 122. The front wall 122 is configured to extend forwardly from the hood 110 towards an opposing end of the receptacle 112 (i.e. the end of the receptacle opposing the end at which the hood is provided). Together, the side walls 116a, 116b, rear wall 118, top wall 120 and front wall 122 of the hood 110 can completely enclose the receptacle 112 from above so that the cavity of the receptacle 112 is completely enclosed. The front wall 122 can be permanently or removably attached at one end to one of the walls of the hood 110 or the front arch member 110a. The other end of the front wall can be removably attached to the opposing end of the receptacle by fastening means such as zip, button or hook-and-loop fasteners, or by providing the front wall 122 with an elasticated edge that can be extended over an upper rim on the receptacle. Alternatively, the front wall 122 does not need to extend all the way to the opposing end of the receptacle and can just extend partially toward the opposing end of the receptacle. In this case, the front wall 122 can be provided with a flexible wireframe for support.

The front wall 122 is made from a flexible material and can be stored within the hood 110 when not in use. For example, the inner surface of the hood 110 could have a pocket (not shown) in which the front wall 122 can be stored in a folded state. One end of the front wall 122 can be permanently attached to the pocket or one of the walls of the hood 110. The front wall 122 can be made from, or at least comprise a portion made from, a mesh or net material to provide breathability and protection from bodies such as insects and the glare of the sun. Alternatively, the front wall 122 can be made from a close-knit material.

It will be recognised that even if the front wall 122 is not extended or provided, the first and second fan units 126, 128 mounted in the in hood 110 will still provide a similar effect as the removable cover 10 to provide a clean, temperature-controlled environment for the child in the child carrier.

The temperature sensor and/or air quality sensor as described above in relation to the cover assembly 10 can also be provided in the hood 110 or receptacle 112 for the same purpose.

The child carrier can comprise attachment means that allow the receptacle 112 to be attached to a frame 160 with wheels 162 so that the child carrier can be transported without the user needing to carry the child carrier. For example, the receptacle and the frame can comprise corresponding releasable snap fit connectors 164a, 164b that allow the child carrier to be attached and detached from the frame 160. The wheels 162 may be permanently attached to the frame or may be releasably coupled to the frame for convenient transport and storage.

It will be apparent to a person skilled in the art from the foregoing description, that modifications and variations can be made to the described embodiments without departing from the scope of the invention as defined by the appended claims.

1. A hood for mounting to a child carrier, the hood comprising:
a pair of side walls, a top wall and an end wall defining a compartment therebetween;
a first fan unit comprising a fan configured, in use, to draw ambient external air therethrough into the compartment; and
a second fan unit comprising a fan configured, in use, to draw therethrough air from within the compartment to the environment outside the compartment;
said first and second fan units being mounted and sealed within a respective opening in a different respective one of the side walls, top wall and rear wall such that, in use, an air flow path is defined through a volume of said compartment between said first and second fan units.

2. A hood according to claim 1, wherein the end wall is a front wall, the hood defining a removable cover assembly for an infant carrier or child transport device comprising a receptacle or seat for receiving an infant or child, in use, said side, top and front walls defining a canopy configured to fit over said receptacle or seat to form a compartment enclosing an infant or child therein, in use; where said canopy is formed of a flexible material.

3. A hood according to claim 1, wherein said first fan unit further comprises a filter member.

4. A hood according to claim 3, wherein said first fan unit comprises a recess for receiving a replaceable filter member in an air flow path of said outside external air.

5. A hood according to claim 4, wherein said replaceable filter member comprises an active carbon filter.

6. A hood according to claim 1, wherein at least one of the first and second fan units additionally comprises a power supply, and each said fan is electrically coupled to the, or each respective, power supply.

7. (canceled)

8. (canceled)

9. A hood according to claim 6, wherein at least one of said first and second fan units comprises a power supply recess for removably receiving at least one battery and including a contact for electronically coupling said at least one battery, in use, to a respective fan.

10. A hood according to claim 6, wherein only one of said first and second fan units comprises a power supply, and said first and second fan units are both electrically coupled thereto.

11. (canceled)

12. A hood according to claim 1, further comprising a temperature sensor configured, in use, to obtain data representative of the temperature within the compartment.

13. (canceled)

14. A hood according to claim 1, wherein said fan units additionally comprise a control unit configured, in use, to selectively vary the speed of rotation of said fans.

15. A hood according to claim 14, further comprising a temperature sensor configured, in use, to obtain data representative of the temperature within the compartment, wherein said temperature sensor is communicably coupled to said control unit, and said control unit is configured to vary the speed of rotation of said fans in response to changes in said internal temperature.

16. A hood according to claim 15, wherein said control unit has a pre-programmed temperature range and is configured, in use, to compare said temperature data against said pre-programmed temperature range, and selectively operate the fans based on this comparison.

17. A hood according to claim 1, further comprising an air quality sensor configured, in use, to obtain data representative of the air quality within said compartment; and a display unit configured, in use, to display said data representative of air quality.

18. (canceled)

19. A hood according to claim 1, further comprising at least one of a temperature sensor configured, in use, to obtain data representative of the temperature within the compartment communicably, coupled with a program on a user mobile device, and an air quality sensor configured, in use, to obtain data representative of the air quality within said compartment, communicably coupled with a program on a user mobile device.

20. A hood according to claim 1, wherein the first fan unit and the second fan unit are mounted and sealed in a different respective side wall so as to oppose each other.

21. A hood according to claim 1, further comprising a front wall extendable forwardly from the hood, wherein the front wall is made from a mesh material, and comprises an elasticated edge.

22. A hood according to claim 21, wherein the hood comprises a pocket for storing the front wall when not extended.

23. (canceled)

24. (canceled)

25. A child carrier comprising:
a receptacle defining an open cavity for receiving an infant in use;
a hood according to claim 1 mounted at one end of the receptacle, the compartment being defined over the cavity.

26. A child carrier according to claim 25, wherein the hood is pivotably mounted to the receptacle and is moveable relative to the receptacle between an expanded state and a collapsed state.

27. A child carrier according to claim 25, wherein the front wall is extendable from the hood towards an opposing end of the receptacle, wherein the front wall of the hood comprises fastening means for fastening the front wall to the opposing end of the receptacle, wherein when the hood is in the expanded state and the front wall is extended from the hood to the opposing side of the receptacle, the hood and front wall completely enclose the cavity from above.

28. (canceled)

29. (canceled)

30. A child transport device comprising:
a child carrier according to claim 25;
a frame attached to the child carrier; and
at least one wheel attached to the frame.

31. A hood according to claim 1, wherein the end wall is a rear wall.
